(19) United States
(12) Patent Application Publication
(10) Pub. No.: US 2003/0227275 A1
(43) Pub. Date: Dec. 11, 2003

(54) Battery pack and battery pack with AC/DC conversion circuit board

(76) Inventors: Takashi Kishi, Yokosuka-shi (JP); Yuji Satoh, Sagamihara-shi (JP); Hideaki Morishima, Ichikawa-shi (JP); Motoya Kanda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/400,554

(22) Filed: Mar. 28, 2003

(30) Foreign Application Priority Data
Mar. 29, 2002 (JP) 2002-097893

(51) Int. Cl. H02J 7/00

(52) U.S. Cl. 320/107

(57) ABSTRACT

The present invention provides a battery pack electrically connected to an AC/DC conversion circuit board comprising an exothermic element, comprising an outer case including a wall portion having an outside that faces the AC/DC conversion circuit board, a combination battery of lithium ion secondary cells provided in the outer case and a battery control circuit board provided in the outer case, between the wall portion and the combination battery.

### CROSS-REFERENCE TO RELATED APPLICATIONS

This application is based upon and claims the benefit of priority from the prior Japanese Patent Application No. 2002-097893, filed Mar. 29, 2002, the entire contents of which are incorporated herein by reference.

### BACKGROUND OF THE INVENTION

1. Field of the Invention

The present invention relates to a battery pack and a battery pack with AC/DC conversion circuit board.

2. Description of the Related Art

Lithium ion secondary batteries are recently noticed as high energy density batteries, and are widely used in portable appliances, personal computers and the like. A higher output can be obtained by improvement of lithium ion secondary batteries, and applications are extended to cordless vacuum cleaners and others. In portable appliances and personal computers, large current output is not required. Therefore, enhancement of energy density is important, and hence the active materials of positive and negative electrodes have been improved. On the other hand, a large current is needed in motor driven machines such as cordless vacuum cleaners, what is important is the prevention of heat generation of lithium ion secondary batteries at the time of discharge, and a method of cooling a lithium ion secondary battery pack has been studied.

Jpn. Pat. Appln. KOKAI Publication No. 2002-101572 discloses an uninterruptible power supply device comprising a power supply unit for converting an alternating-current into direct current and driving a predetermined electronic appliance main body, and an uninterruptible power source unit for guaranteeing operation of the electronic appliance in case of stop of supply from an alternating-current power. This uninterruptible power source unit comprises a secondary battery (for example, nickel hydride secondary battery) that is charged by the direct current from the power supply unit and supplies the power to the electronic appliance main body in case of stop of the alternating-current power, and a cooling fan for cooling the secondary battery.

In the invention disclosed in the Jpn. Pat. Appln. KOKAI publication, however, cooling is performed in connection with only the heat generated when the secondary battery is discharged. To radiate heat from the heat-generating components other than the secondary battery, the components are spaced far from the secondary battery. In other words, the devices for supplying power are arranged, spaced apart from one another. Consequently, the devices occupy a large space in the apparatus, making it difficult to design the apparatus having a small size.

The cooling fan can hardly apply air uniformly to the secondary battery. The difference in temperature between that part of the battery which is applied with air is and the other part which is not applied with air is great. Inevitably, the secondary battery cannot have a sufficiently long charge-and-discharge cycle life.

### BRIEF SUMMARY OF THE INVENTION

It is an object of the invention to provide a battery pack and a battery pack with AC/DC conversion circuit board capable of suppressing deterioration of charge and discharge cycle life.

According to a first aspect of the present invention, there is provided a battery pack used as a substitute AC power supply in case of an AC power outage in a power supply system having an AC/DC conversion circuit board that converts an alternating current input into a direct current output, comprising:

an outer case including a wall portion having an outside that faces the AC/DC conversion circuit board;

a combination battery of lithium ion secondary cells provided in the outer case; and

a battery control circuit board provided in the outer case, between the wall portion and the combination battery.

According to a second aspect of the present invention, there is provided a battery pack electrically connected to an AC/DC conversion circuit board comprising an exothermic element, comprising:

an outer case including a wall portion having an outside that faces the AC/DC conversion circuit board;

a combination battery of lithium ion secondary cells provided in the outer case; and

a battery control circuit board provided in the outer case, between the wall portion and the combination battery.

According to a third aspect of the present invention, there is provided a battery pack with AC/DC conversion circuit board, comprising:

an AC/DC conversion circuit board comprising an exothermic element; and

a battery pack main body electrically connected to the AC/DC conversion circuit board;

wherein the battery pack main body comprises:

an outer case including a wall portion having an outside that faces the AC/DC conversion circuit board;

a combination battery of lithium ion secondary cells provided in the outer case; and

a battery control circuit board provided in the outer case, between the wall portion and the combination battery.

### BRIEF DESCRIPTION OF THE SEVERAL VIEWS OF THE DRAWING

FIG. 1 is a perspective view schematically showing an example of a state in which a battery pack of the invention is provided in an ATX power supply device.

FIG. 2 is a side view of the battery pack in FIG. 1 as seen from the positive and negative electrode terminal side.

FIG. 3 is a sectional view obtained by cutting off the battery pack in FIG. 1 along the line III-III.

FIG. 4 is a sectional view obtained by cutting off the battery pack in FIG. 1 in a horizontal direction.

FIG. 5 is a schematic view showing a configuration of a combination battery and a battery control circuit board.

FIG. 6 is a schematic view showing another configuration of the combination battery and the protection control circuit board.

FIG. 7 is a schematic view showing a still further configuration of the combination battery and the protection control circuit board.

FIG. 8 is a perspective view schematically showing positional relation between an exothermic element, a battery control circuit board and a combination battery.

FIG. 9 is a plan view schematically showing an example of positional relation between a lithium ion secondary battery pack and an AC/DC conversion circuit board.

FIG. 10 is a plan view schematically showing another example of positional relation between the lithium ion secondary battery pack and the AC/DC conversion circuit board.

FIG. 11 is a plan view schematically showing a still further example of positional relation between the lithium ion secondary battery pack and the AC/DC conversion circuit board.

FIG. 12 is a top view schematically showing a configuration of the lithium ion secondary battery pack and the AC/DC conversion circuit board in the ATX power supply device.

FIG. 13 is a side view of FIG. 12.

FIG. 14 is a top view schematically showing another configuration of the lithium ion secondary battery pack and the AC/DC conversion circuit board in the ATX power supply device.

FIG. 15 is a side view of FIG. 14.

FIG. 16 is a side view schematically showing a still further configuration of the lithium ion secondary battery pack and the AC/DC conversion circuit board in the ATX power supply device.

FIG. 17 is a top view schematically showing a still further configuration of the lithium ion secondary battery pack and the AC/DC conversion circuit board in the ATX power supply device in Example 1.

FIG. 18 is a side view of FIG. 17.

FIG. 19 is a top view schematically showing a still further configuration of the lithium ion secondary battery pack and the AC/DC conversion circuit board in the ATX power supply device in Example 3.

FIG. 20 is a side view of FIG. 19.

FIG. 21 is a side view schematically showing a still further configuration of the lithium ion secondary battery pack and the AC/DC conversion circuit board in the ATX power supply device in Example 4.

FIG. 22 is a side view schematically showing a still further configuration of the lithium ion secondary battery pack and the AC/DC conversion circuit board in the ATX power supply device in Example 5.

FIG. 23 is a top view schematically showing a still further configuration of the lithium ion secondary battery pack and the AC/DC conversion circuit. board in the ATX power supply device in Example 6.

FIG. 24 is a top view schematically showing a still further configuration of the lithium ion secondary battery pack and the AC/DC conversion circuit board in the ATX power supply device in Example 7.

FIG. 25 is a top view schematically showing a still further configuration of the lithium ion secondary battery pack and the AC/DC conversion circuit board in the ATX power supply device in Example 8.

### DETAILED DESCRIPTION OF THE INVENTION

First embodiment of a battery pack according to the present invention will be described.

The battery pack is one functioning as a substitute power supply in case of an AC power outage in a power supply system comprising an AC/DC conversion circuit board that converts an AC power into a DC power, comprising:

an outer case including a wall portion having an outside that faces the AC/DC conversion circuit board;

a combination battery of lithium ion secondary cells provided in the outer case; and

a circuit board provided in the outer case and between an inside of the wall portion and the combination battery.

The circuit board is preferably a battery control circuit board. Herein, the battery control circuit board is a circuit board for controlling charging and discharging of a combination battery in a battery pack, and is different from an AC/DC conversion circuit board. This battery control circuit board comprises an insulating substrate and a battery control circuit provided thereon. The battery control circuit is, for example, a circuit which controls charging and discharging of the combination battery, or a protection circuit or safety circuit which assures safety of the combination battery. The protection circuit and safety circuit can be realized by, for example, at least one of an overcharge protection circuit and an overdischarge protection circuit. As the battery control circuit, meanwhile, a circuit having functions of both control of charging and discharging and assurance of safety can be used.

In the battery pack of the invention, the battery control circuit board preferably includes a glass epoxy substrate or paper phenol laminate as an insulating substrate.

In the battery pack of the invention, the outer case preferably includes a first case of box shape, and a second case functioning as a lid to cover an opening of the first case.

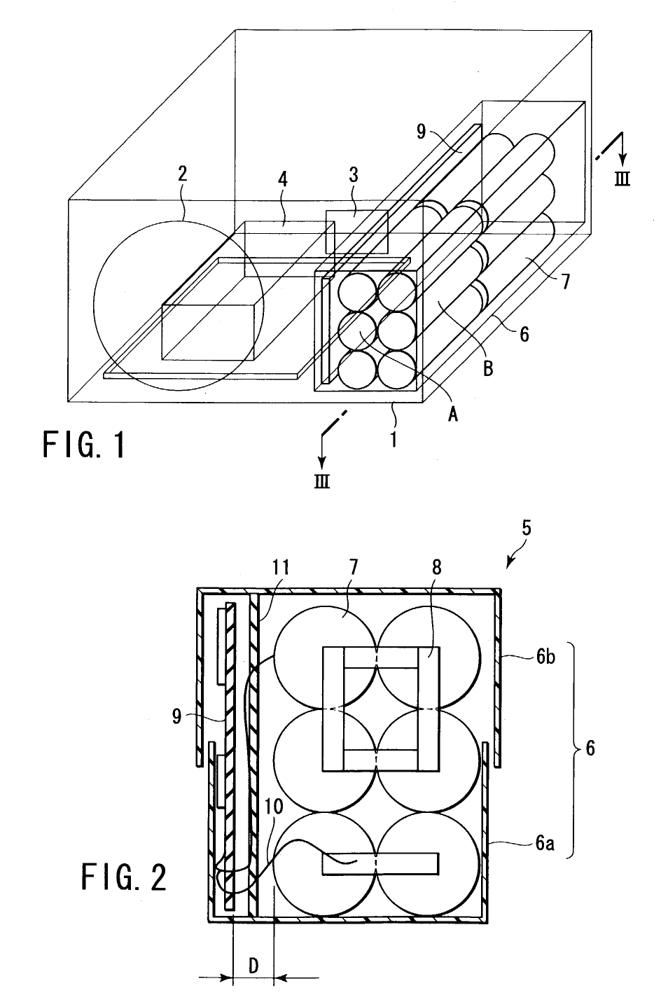

An example of the battery pack according to the invention is explained by referring to FIG. 1 to FIG. 4.

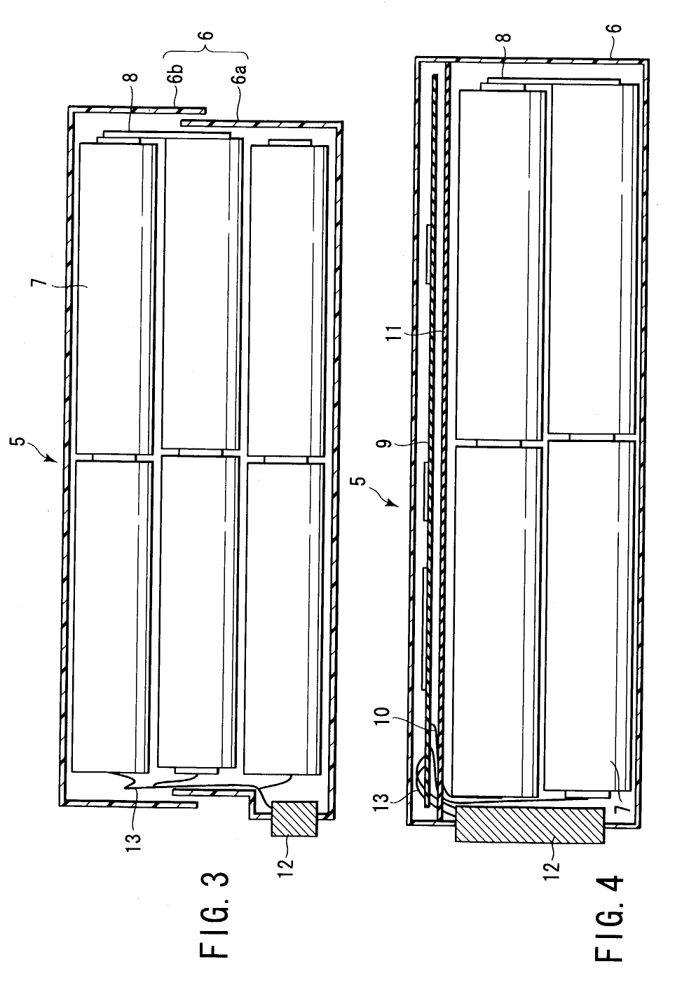

FIG. 1 is a perspective view schematically showing an example of a state in which a lithium ion secondary battery pack of the invention is provided in an ATX power supply device, FIG. 2 is a side view of the lithium ion secondary battery pack in FIG. 1 as seen from the positive and negative electrode terminal side, FIG. 3 is a vertical sectional view of the lithium ion secondary battery pack in FIG. 1 along the line III-III, and FIG. 4 is a longitudinal sectional view of the lithium ion secondary battery pack in FIG. 1.

The ATX power supply device receives power from an external AC power supply, and converts it into a DC outputs of a predetermined voltages. A fan 2 is attached to the front side of the ATX power supply housing 1. An AC input terminal 3 is provided at the side of the fan 2. An AC/DC conversion circuit board 4 is installed in the ATX power supply housing 1, and is connected to the input terminal 3 and an output terminal (not shown).

A lithium ion secondary battery pack 5 comprises an outer case 6 including a lower case 6a of a long box shape (first case of box shape) and an upper case 6b of long box shape (second case), and a combination battery composed of twelve cylindrical lithium ion secondary cells 7 accommodated in the outer case 6 with a longitudinal direction of the cells 7 being vertical to a gravitational direction. The twelve cylindrical lithium secondary cells 7 are arranged in two lateral rows and two longitudinal rows, and stacked up in three layers. Two lithium ion secondary cells 7 are connected in parallel by connecting or welding leads 8 to compose one unit, and six units are connected in series by connecting or welding leads 8 to compose the combination battery. The outer case 6 is preferably formed of a resin, such as ABS resin or polycarbonate, from the viewpoint of insulation. The leads 8 are made of metal such as nickel or aluminum.

A protection control circuit board 9 realizing at least one function of charge and discharge control, an overcharge preventive mechanism and an overdischarge preventive mechanism, etc. is one example of the battery control circuit board. The protection control circuit board 9 is arranged between the inner wall of the outer case 6 and the side periphery of the lithium ion secondary cells 7. The protection control circuit board 9 and combination battery are electrically connected by means of first leads 10. An insulating plate 11 is arranged between the protection control circuit board 9 and the side periphery of the lithium ion secondary cells 7. An external connection terminal 12 is provided on the inner wall of the outer case that faces positive and negative electrode terminals of the lithium ion secondary cells 7. The external connection terminal 12 is electrically connected to a battery pack connection terminal in the ATX power supply device. The external connection terminal 12 and protection control circuit board 9 are electrically connected by means of second leads 13. The element for monitoring and controlling the voltage and current, which is not mounted on the protection control circuit board 9, may be externally attached to the lithium ion secondary battery pack.

When a lithium ion secondary battery pack 5 having such a configuration is inserted in the ATX power supply housing 1, and the external connection terminal 12 of the battery pack 5 is connected to the battery pack connection terminal in the ATX power supply device, and the protection control circuit board 9 is located at the AC/DC conversion circuit board 4 side. That is, the outside of the wall portion of the outer case 6 faces the AC/DC conversion circuit board 4, and the protection control circuit board 9 is arranged between the inside of the wall portion and the combination battery.

In the ATX power supply device explained herein, the input from the AC external power supply to the AC input terminal 3 is converted into a DC outputs having a predetermined voltages by the AC/DC conversion circuit board 4. The lithium ion secondary battery pack 5 is charged by this converted DC output and is set to be always in a charged state. When the input from the AC external power supply is stopped due to an external factor such as power failure, the electric power charged in the lithium ion secondary battery pack 5 is used as substitute power.

The inside of the ATX power supply housing 1 is heated to 50° C. or more by the heat from the AC/DC conversion circuit board 4. By providing the protection control circuit board 9 between the outside of the outer case wall, which faces the AC/DC conversion circuit board 4, and the combination battery, the radiation heat from the AC/DC conversion circuit board 4 can be absorbed by the outer case wall and the protection control circuit board 9. Therefore, excessive heating of part of the combination battery is avoided, and the temperature difference can be decreased between the cell at the AC/DC conversion circuit board 4 side and the cell at the wall side of the ATX power supply housing 1. As a result, fluctuations of the charge and discharge characteristics among cells composing the combination battery can be decreased, and the charge and discharge cycle life of the lithium ion secondary battery pack 5 can be extended.

The lithium ion secondary battery pack 5 is only occasionally slightly charged (about once a month) while the power is normally supplied from the AC external power supply, and it is always in a charged state, and thereby is rarely discharged. When the input from the AC external power supply is interrupted dud to power failure or the like, the lithium ion secondary battery pack 5 is discharged at a high rate and functions as a substitute power supply. Although the heat generation suddenly occurs in the cell by this high rate discharge, since the battery pack 5 keeps a low temperature by heat absorption by the protection control circuit board 9 before the high rate discharge. Accordingly, the battery temperature is not raised excessively by the high rate discharge, so that safety is assured.

Further, by providing the insulating plate 11 between the combination battery and the protection control circuit board 9, short-circuiting of the protection circuit board by a battery can or connection lead can be prevented, and the heat shielding effect can be further enhanced. Moreover, to prevent damage of the battery control circuit board due to leakage of battery electrolyte, a resin plate or insulating paper is preferably used as the insulating plate.

Incidentally, the ATX power supply device has a fan 2 attached thereto. By using this fan 2, if attempted to control battery temperature rise due to heat from the AC/DC conversion circuit board 4, however, the following problems occur.

Since the fan is designed to cool the AC/DC converter, the fan is installed in a place remote from the lithium ion battery pack 5, thus it cannot cool the battery.

If the position of the fan is changed to cool the battery pack, only a part of the battery pack is exposed to cool wind, thus the temperature difference increases between the portion of the cells exposed to wind and the part not exposed to wind, which may lead to shortening of the cycle life of the battery pack. Above all, the original purpose of cooling of the AC/DC converter is sacrificed.

The protection control circuit board includes an insulating substrate, and a circuit pattern provided on the insulating substrate. The insulating substrate is made of, preferably, a glass epoxy substrate or paper phenol laminate. Such a protection control circuit board 9 is high in the effect of shielding the radiation heat from the AC/DC conversion circuit board 4. In order to obtain a sufficient heat shielding effect, the thickness of the insulating substrate of the protection control circuit board 9 is preferred to be 0.8 mm or more. The heat shielding effect is higher if the thickness of the insulating substrate is increased. However, if the thickness of the insulating substrate exceeds 3.2 mm, it is hard to miniaturize the battery pack and a higher cost is involved, and hence the thickness of the insulating substrate is preferred to be in a range of 0.8 mm to 3.2 mm.

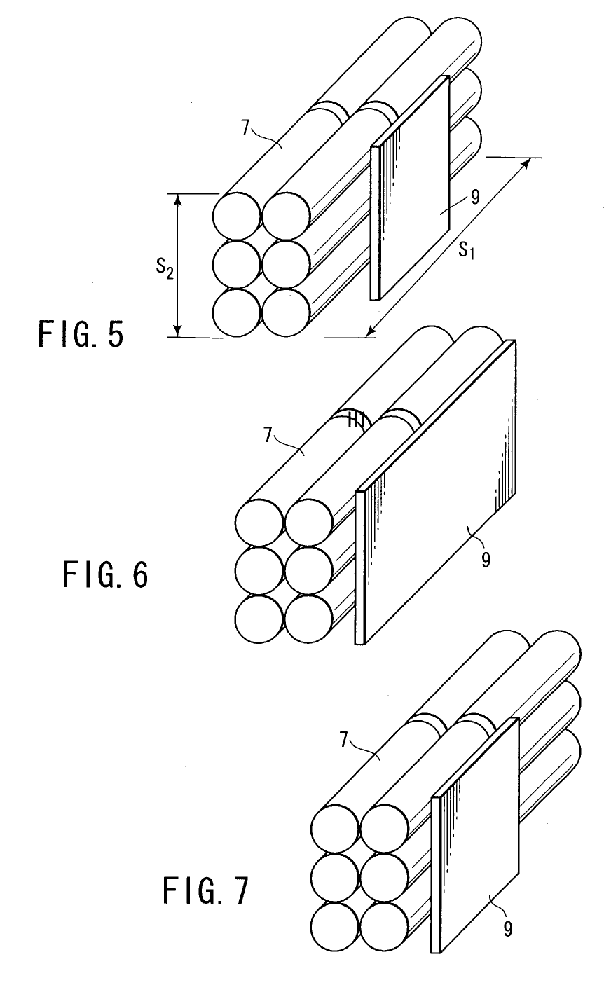

The protection control circuit board 9 preferably faces the side periphery of the lithium ion secondary cells 7 either by way of the insulating plate 11 or directly. In such a configuration, the size of the lithium ion secondary battery pack 5 can be reduced, and the temperature difference among cells can be further decreased, so that the cycle life of the battery pack can be extended. Assuming a projection area of the side face of the combination battery on the protection control circuit board 9 to be 100%, an area of the protection control circuit board 9 is preferably equivalent to 50% or more of the projection area. The projection area is a longitudinal side of the combination battery, where a side is considered a rectangle of a height and length respectively equal to a height S₂ and length S₁ of the combination battery, as shown in FIG. 5. Meanwhile, when the area of the protection control circuit board 9 is less than 100% of the projection area, in order to maximize the heat shielding effect by the protection control circuit board, it is preferred to set each cell in the first row to face the protection control circuit board 9. This example is shown in FIG. 5. The protection control circuit board 9 having an area equivalent to 50% of the projection area faces all of the six secondary cells 7 in the first row. It is preferred to uniformly face all of the six secondary cells 7 in the first row. As a result, the temperature environment of each of six secondary cells 7 can be uniform. More preferably, using the protection control circuit board 9 having an area more than 100% of the projection area, as shown in FIG. 6, the side periphery of each of the six secondary cells 7 in the first row should face the protection control circuit board 9. In FIG. 7, the protection control circuit board 9 having an area equivalent to 50% of the projection area faces the three secondary cells 7 located in the first row. According to this arrangement as shown in FIG. 7, the temperature environment of each six secondary cells may not be uniform.

Preferably, a gap is provided between the combination battery and the protection control circuit board 9. Such an example is shown in FIG. 2. To enhance the heat shielding effect by the gap and avoid mechanical damage of the protection control circuit board 9 if an impact occurs, a distance D between the protection control circuit board 9 and the combination battery is preferred to be 1 mm or more. Further, from the viewpoint of miniaturizing the lithium ion secondary battery pack and enhancing the volume efficiency, the distance D is preferred to be not more than 8 mm.

When the insulating plate 11 is provided between the protection control circuit board 9 and the combination battery, preferably, a resin plate is used as the insulating plate 11, and the insulating plate 11 is brought into contact with the combination battery, with a gap provided between the protection control circuit board 9 and the combination battery. The size of the gap is preferably 1 mm or more. As a result, the heat shielding effect and resistance to impact by the gap can be enhanced. In addition, from the viewpoint of miniaturizing the lithium ion secondary battery pack and enhancing the volume efficiency, the gap is preferably not more than 8 mm.

The lower case 6a of the outer case 6 is preferred to be shaped like a box. This is effective in preventing damage of the AC/DC conversion circuit board, electronic elements outside of the ATX power supply device and the like due to leakage of electrolyte in the event of battery failure. Therefore, during normal supply of AC power, the auxiliary power source by the lithium ion secondary battery pack is not needed. Accordingly, even if a leakage occurs due to a defect, there is no damage to elements other than the lithium ion secondary battery pack, and only the lithium ion secondary pack need be replaced, thus powersupply is uninterrupted. The bottom area of the box-shaped case is sufficient to accommodate the combination battery and the protection control circuit. The height of the box-shaped case is preferred to have an inner volume for containing the total volume of electrolyte contained in the cells composing the combination battery. More preferably, the lower case of the box shape should have an inner volume for holding half of the electrolyte contained in a unit cell. In the event of leakage due to battery abnormality, all the electrolyte does not leak out, and the majority is held within the electrodes or separator inside the battery. Leakage mostly occurs in a specific cell advanced in deterioration or particularly exposed to an external factor. Accordingly, the lower case of the box shape is sufficient if it has an inner volume for holding half of the electrolyte contained in a unit cell. On the other hand, the upper case 6b is required only to include the combination battery and the protection control circuit, and may have a ventilation hole on the top or at the side.

The lithium ion secondary battery will be explained.

The lithium ion secondary battery comprises a container, an electrode group including a positive electrode and a negative electrode, the electrode group being provided in the container, and a nonaqueous electrolyte held in the electrode group.

Either a metal container or laminate film container can be used as the container. In the foregoing FIG. 1 to FIG. 4, cylindrical lithium ion secondary batteries are shown, but prismatic or thin lithium ion secondary batteries may be also used.

The positive electrode is formed in a thin plate by using a binder and a positive electrode active material. The positive electrode active material includes, for example, at least one oxide selected from the group consisting of lithium-cobalt complex oxide, lithium-nickel complex oxide, lithium-manganese complex oxide, lithium-containing nickel-cobalt oxide, lithium-containing vanadium oxide, titanium disulfide, molybdenum disulfide and other chalcogen compound. The positive electrode is preferred to contain graphite, carbon black or the like as the conductive material. The positive electrode active material is preferably a lithium-cobalt complex compound, lithium-nickel complex compound, or lithium-manganese complex compound, and thereby a nonaqueous electrolyte secondary battery having a large capacity and withstanding a high output can be obtained.

The negative electrode can be prepared by, for example, coating one surface or both surfaces of a current collector with a paste of a negative electrode mixture obtained by dispersing a negative electrode material and a binder in a suitable solvent, followed by drying and, then, pressing the coating formed on the current collector.

The negative electrode material includes, for example, at least one of alkaline metal such as lithium, and a carbonaceous material absorbing and releasing lithium.

The carbonaceous material can be made by, for example, performing a heat treatment to a coke of petroleum or coal, a pitch of petroleum or coal, an organic compound of low molecular weight such as natural gas or lower hydrocarbon, or a synthetic polymer such as polyacrylonitrile or phenol resin. Also, artificial graphite or natural graphite may be used as the carbonaceous material.

A separator is provided between the positive electrode and the negative electrode. The separator is made of, for example, a synthetic resin nonwoven fabric, a polyethylene porous film, a polypropylene porous film, or the like.

The nonaqueous electrolyte contains a nonaqueous solvent, and an electrolyte to be dissolved in the nonaqueous solvent. The nonaqueous electrolyte may be liquid, gel or solid.

The nonaqueous solvent is not particularly limited, and usable examples include ethylene carbonate (EC), propylene carbonate (PC), dimethyl carbonate (DMC), methyl ethyl carbonate (MEC), diethyl carbonate (DEC), γ-butyrolactone (BL), acetonitrile (AN), ethyl acetate (EA), toluene, xylene, and methyl acetate (MA). On the other hand, examples of the electrolyte include lithium salts such as lithium perchlorate, lithium hexafluorphosphate, lithium tetrafluoroborate, lithium hexafluoroarsenate, lithium trifluoromethane sulfonate, bistrifluoromethyl sulfonyl imide lithium.

The combination battery of lithium ion secondary cells is composed by electrically connecting, for example, lithium ion secondary cells in parallel. Also, the combination battery can be obtained by connecting a plurality of lithium ion secondary cells in parallel to obtain at least one unit, and followed by connecting said at least one unit in series. Although the connecting method is not particularly specified, the cells can be electrically connected by contacting or welding by using metal leads of nickel, aluminum or the like.

Second embodiment of a battery pack according to the present invention will be described below.

This battery pack is used in a state being connected electrically to an AC/DC conversion circuit board for converting the alternating-current input into a direct current output. This battery pack functions as a substitute power supply when the input from the external alternating-current power supply to the AC/DC conversion circuit board is stopped in the power supply system comprising the AC/DC conversion circuit board. The AC/DC conversion circuit board comprises at least one exothermic element selected from a group consisting of a transformer, a regulator, and an IGBT (insulated gate bipolar transistor).

The battery pack is preferred to satisfy the following formula (1).

0.5×S≦X≦S (1)

FIG. 8 is a perspective view schematically showing positional relation among a heat generating part 14 of the exothermic element, a protection control circuit board 9, and a combination battery 16. Plane Y including a heat shielding surface, whose example is a principal plane, of the protection control circuit board 9 is a plane enclosed by dotted line in FIG. 8. In the diagram, symbol S is an area surrounded by a boundary in the plane Y. The boundary is formed by intersecting a straight line group L with the plane Y, the straight line group L connecting the heat generating part 14 of the exothermic element and the combination battery 16. The area S is a plane enclosed by single dot chain line in FIG. 8. The area S is an area necessary for shielding the radiation heat released from the heat generating part 14. Symbol X is an area of the heat shielding surface of the circuit board 9 actually included in the area S. Specifically, as shown in FIG. 8, the area X is an area where the area S and the heat shielding surface of the protection control circuit board 9 are overlapped with each other. In FIG. 8, the shaded region is the area X.

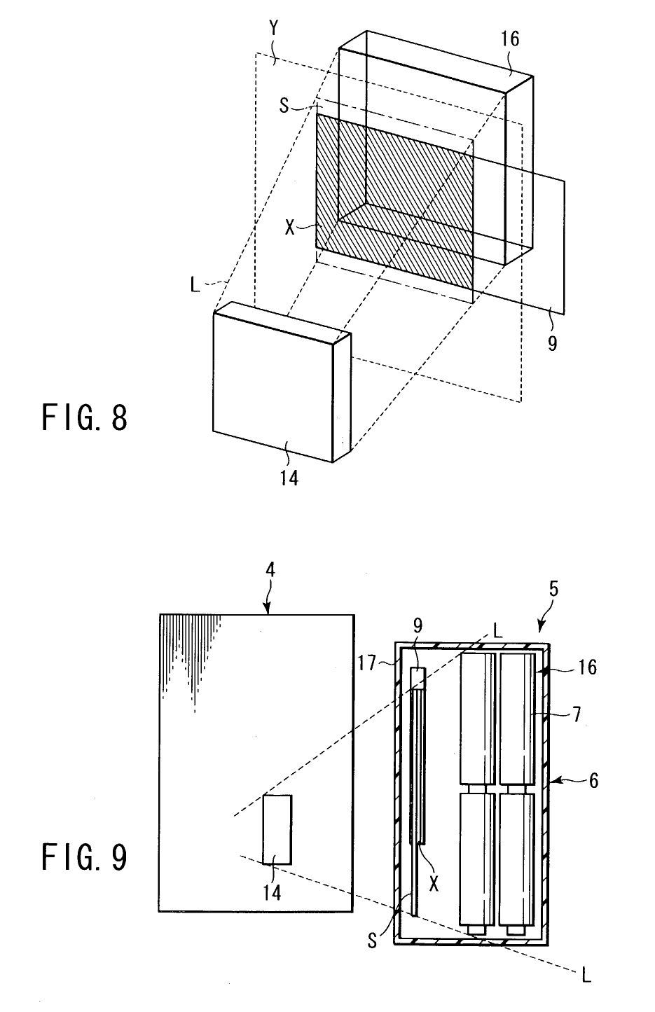

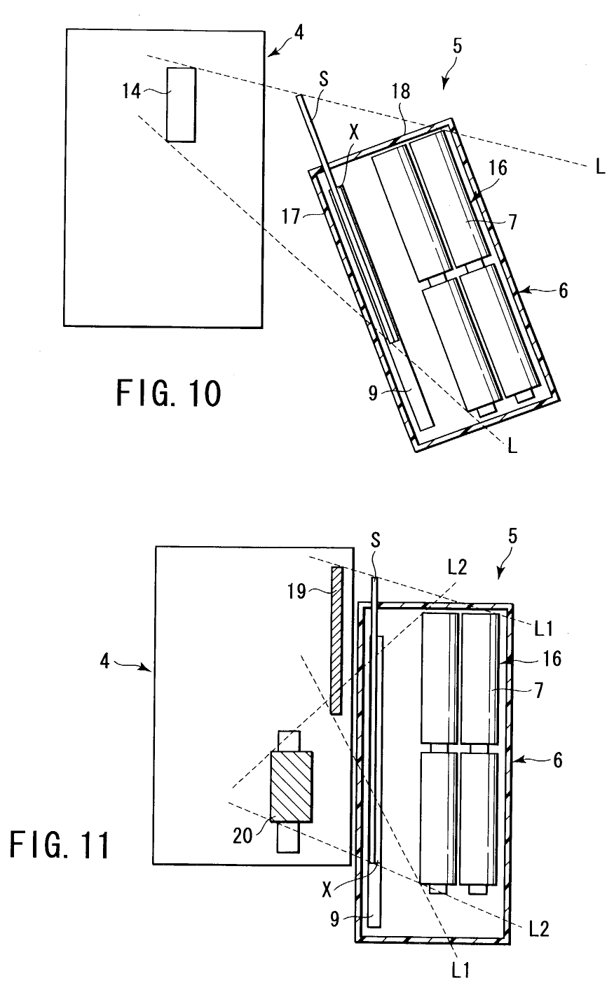

FIG. 9 and FIG. 10 are plan views schematically showing the positional relation between the battery pack and the AC/DC conversion circuit board. In FIG. 9 and FIG. 10, the same members as shown in the foregoing drawings are identified with the same reference numerals, and a duplicate explanation is omitted.

In FIG. 9, a circuit pattern including exothermic elements that has the heat generating part 14 is formed on a principal surface of the AC/DC conversion circuit board 4. The battery pack 5 is arranged parallel and next to the AC/DC conversion circuit board 4. A longer side face 17 of the outer case 6 is opposite to the heat generating part 14. In each cell 7 composing the combination battery, the outer circumference is facing the heat generating part 14 interposed by the longer side surface 17. The protection control circuit board 9 is arranged between the longer side surface 17 and the combination battery 16. The area S is an area in which a straight line group L connecting the heat generating part 14 of the exothermic element and the combination battery 16 intersects with a plane including the heat shielding surface (for example, principal plane) of the protection control circuit board 9. The area X is an area where the heat shielding plane of the protection control circuit board 9 is overlapped with the area S. In the case of FIG. 9, the area X is 50% or more and less than 100% of the area S.

In FIG. 10, the battery pack 5 is arranged obliquely next to the AC/DC conversion circuit board 4. The longer side surface 17 and a shorter side surface 18 of the outer case 6 are opposite to the heat generating part 14. In each cell 7 composing the combination battery 16, the outer circumferential surface is opposite to the heat generating part 14 interposed by the longer side surface 17. The protection control circuit board 9 is arranged between the longer side surface 17 and the combination battery 16. The area S is an area in which the straight line group L connecting the heat generating part 14 of the exothermic element and the combination battery 16 intersects with a plane including the heat shielding surface (for example, principal plane) of the protection control circuit board 9. The area X is an area where the heat shielding plane of the protection control circuit board 9 is overlapped with the area S. In the case of FIG. 10, the area X is 50% or more and less than 100% of the area S.

FIG. 11 shows an example of parallel configuration of the battery pack 5, adjacently to an AC/DC conversion circuit board 4 having two kinds of exothermic element. On the principal plane of this AC/DC conversion circuit board 4, there is formed a circuit pattern including a first exothermic element having a heat generating part 19 (shaded region in FIG. 11), and a second exothermic element having a heat generating part 20 (shaded region in FIG. 11). In this case, the area S is a region formed by a straight line group L₁ connecting the heat generating part 19 of the first exothermic element and the combination battery 16 and a straight line group L₂ connecting the heat generating part 20 of the second exothermic element and the combination battery 16, L₁ and L₂ intersecting with a plane including the heat shielding surface (for example, principal plane) of the protection control circuit board 9. The area X is an area where the heat shielding plane of the protection control circuit board 9 and the area S are overlapped with each other. In the case of FIG. 11, the area X is 50% or more and less than 100% of the area S.

Exothermic elements contained in the AC/DC conversion circuit include, for example, at least one element selected from the group consisting of those generating heat in part of elements such as transistors, those generating heat from the element, and cooling fin such as cooling plate or heat sink attached to the element. By defining the area X of the heat shielding surface of the battery control circuit board included in the area S at 0.5S or more, the heat generating portion included in the exothermic element can be shielded by the battery control circuit board, and therefore thermal deterioration of the cells at the AC/DC conversion circuit side can be suppressed. As a result, fluctuations of the charge and discharge characteristics in the cells for composing the combination battery can be suppressed, and the charge and discharge cycle life of the battery pack can be enhanced. If the area X is less than 100% of the area S, it is preferred to shield uniformly all of the cells located at the battery control circuit board side (cells A in the first row, for example, in FIG. 1). Accordingly, since deterioration of cells can be prevented, the cycle life of the lithium ion secondary battery pack can be extended. A further preferred range of the area X is 0.8S to S, which, therefore, can shield almost all parts of the electrode group in the unit cells for composing the combination battery. Most preferably, the area X should be equal to the area S. As a result, the temperature difference of the cells for composing the combination battery can be minimized, so that the charge and discharge life of the battery pack can be further enhanced.

When the area X is in a range of 0.5S to S, the area of the heat shielding surface of the battery control circuit board is preferred to be in a range of 50 to 100% of the projection area. The projection area is an area where the side face of the combination battery projects on the heat shielding surface of the battery control circuit board. Specifically, the projection area is a longitudinal side of the combination battery, where a side is considered a rectangle of a height and length respectively equal to a height and length of the combination battery. In such a configuration, a sufficient heat shielding effect can be obtained without greatly increasing the dead space in the battery pack. A more preferable range of the area of the battery control circuit board is a range of 90 to 100% of the projection area.

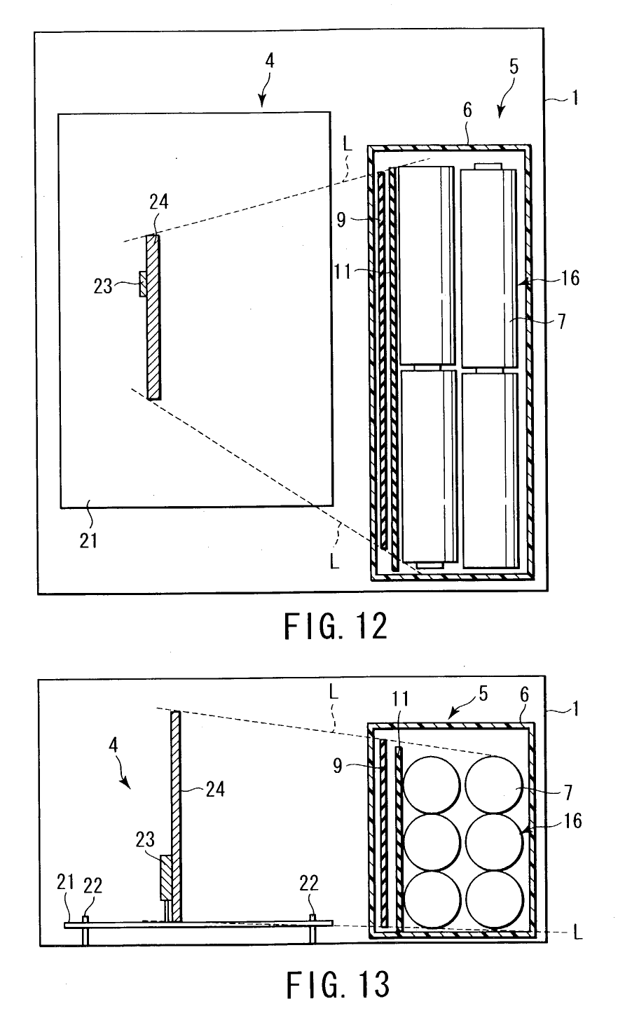

Second embodiment of a battery pack according to the present invention will be explained by referring to FIG. 12 to FIG. 16. Note that, of the members shown in FIG. 12 to FIG. 16, those explained in the foregoing drawings are identified with the same reference numerals and explanation is omitted.

FIG. 12 and FIG. 13 are schematic views in which main exothermic elements contained in the AC/DC conversion circuit board are regulators. For example, inside of the bottom of the ATX power supply housing 1 formed of metal material, an AC/DC conversion circuit board main body 21 is fixed in a state being cleared from the bottom inside by means of a support pin 22. The support pin 22 is made of, for example, resin or metal. A regulator 23 is one of the elements composing the circuit pattern formed on the principal plane of the AC/DC conversion circuit body main body 21. This regulator 23 has a cooling plate 24 made of metal for cooling. A heat generating part comprises the regulator 23 and the cooling plate 24. The area S necessary for shielding the heat released from the regulator 23 and cooling plate 24 by the protection control circuit board 9 is a region in which the straight line group L connecting the regulator 23, the cooling plate 24 and combination battery 16 intersects with the plane including the heat shielding surface (for example, principal plane) of the protection control circuit board 9. In the case of FIG. 12 and FIG. 13, since the area of the heat shielding surface of the protection control circuit board 9 includes the area S, the area X is equal to the area S.

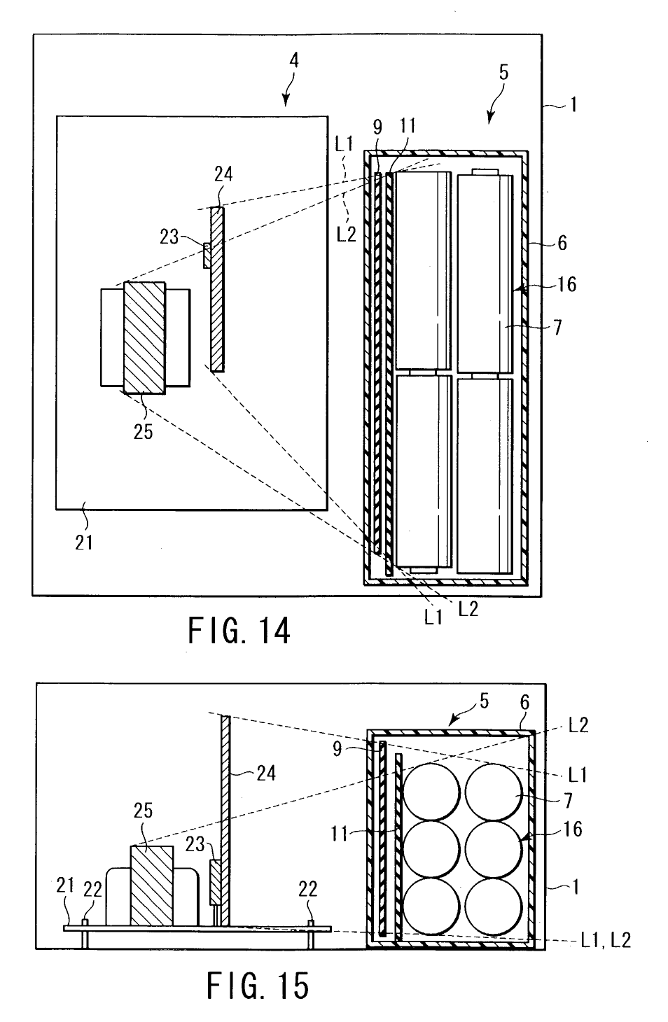

In FIG. 14 and FIG. 15, plural heat generating parts are included in the AC/DC conversion circuit. The circuit pattern formed on the principal plane of the AC/DC conversion circuit main body 21 includes as principal exothermic parts the regulator 23, cooling plate 24, and transformer. The area S is an area necessary for shielding the heat released from the regulator 23, cooling plate 24, and transformer heat generating part 25 (shaded area in the drawing) by the protection control circuit board 9. This area S is a region formed by the straight line group L₁ connecting the cooling plate 24 and combination battery 16 and the straight line group L₂ connecting the transformer heat generating part 25 and combination battery 16, L₁ and L₂ intersecting with a plane including the heat shielding surface (for example, principal plane) of the protection control circuit board 9. In the case of FIG. 14 and FIG. 15, the area X is equal to the area S because all area of the heat shielding surface of the protection control circuit 9 includes the area S.

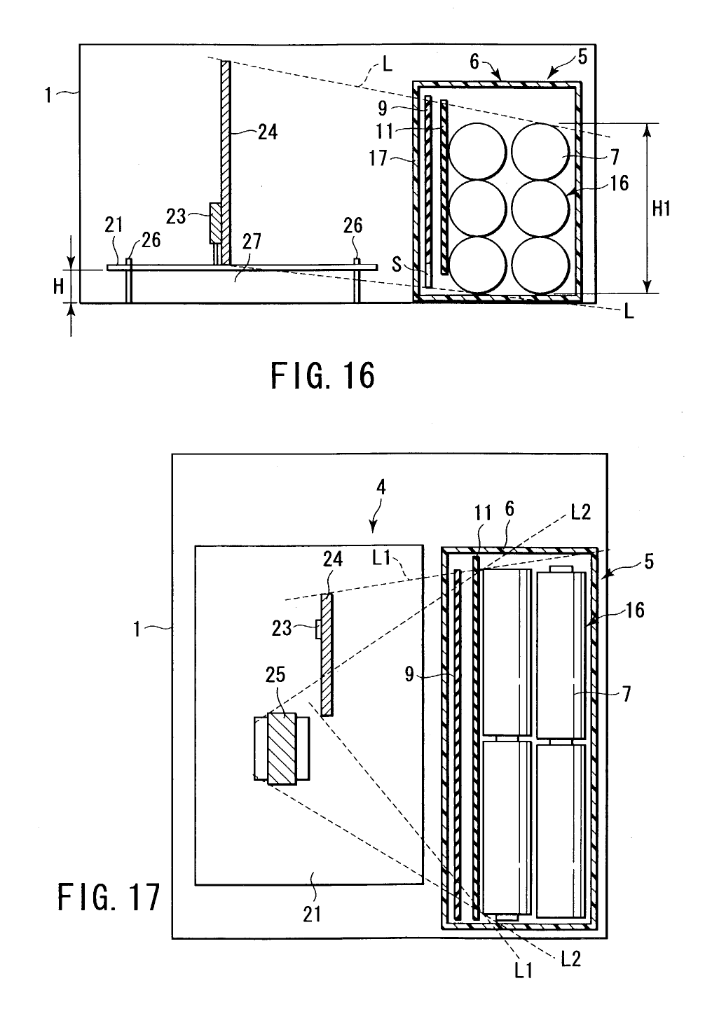

When the AC/DC conversion circuit main body 21 has the insulating substrate that has a thickness of 0.8 mm to 3.2 mm and is formed by a glass epoxy substrate or a paper phenol laminate, the AC/DC conversion circuit main body 21 can contribute to heat shielding. In this case, the height of the AC/DC conversion circuit main body 21 from the inside of the bottom of the ATX power supply housing 1 is preferably higher than the bottom of the combination battery 16 and lower than the height of the combination battery 16. Such an example is shown in FIG. 16.

Inside of the bottom of the ATX power supply housing 1, the AC/DC conversion circuit board main body 21 is fixed by means of support pins 26. The height H of the AC/DC conversion circuit board 21 from the inside of the bottom is higher than that from the bottom of the combination battery 16, and lower than the height H₁ of the combination battery. In such a configuration, the longer side surface 17 of the outer case 6 is opposite to the regulator 23, the cooling plate 24, the side face of the AC/DC conversion circuit board main body 21 and a space 27 formed between the AC/DC conversion circuit board main body 21 and the inside of the bottom of housing 1. The protection control circuit board 9 is provided in the area S so as to face the cooling plate 24 interposed by the longer side surface 17 of the outer case 6. Of the intersecting area of the straight line group L connecting the regulator 23, cooling plate 24 and combination battery 16 and the plane including the protection control circuit board 9, the area that faces the battery control circuit board main body 21 and space 27 interposed by the longer side face 17 of the outer case 6 is shielded by the AC/DC conversion circuit board main body 21, and hence this area can be subtracted from the required heat shielding area S.

According to the battery pack having the configuration explained in FIG. 16, the required heat shielding area S is substantially consisting of the heat shielding area of the protection control circuit board 9 and the exothermic element non-existing region 27 provided by the AC/DC conversion circuit board main body 21. As a result, the heat shielding area X by the protection control circuit board 9 is 100% of the area S that excludes the portion shielded by the AC/DC conversion circuit board 21, and a sufficient heat shielding effect can be obtained.

In FIG. 16, the AC/DC conversion circuit board main body 21 is arranged horizontally in the housing 1, but the AC/DC conversion circuit board main body 21 may be also arranged obliquely to the inside of the housing 1.

One embodiment of a battery packet with AC/DC conversion circuit board will be described below.

This battery pack comprises the battery pack according to the present invention and the AC/DC conversion circuit board. The AC/DC conversion circuit board are the same as those explained in the first and second embodiments of the battery pack.

Preferred examples of the invention will be explained below while referring to FIG. 1 to FIG. 16, and FIG. 17 to FIG. 26. In FIG. 17 to FIG. 26, explanation of members of same reference numerals in FIG. 1 to FIG. 16 is omitted.

### EXAMPLE 1

<Fabrication of Lithium Ion Secondary Cell>

90 wt. % of lithium-cobalt oxide (LiCoO₂) powder, 2 wt. % of acetylene black, 3 wt. % of graphite, and 5 wt. % of polyvinylidene fluoride as binder are mixed with N-methyl pyrrolidone as solvent, and slurry was obtained. The obtained slurry was applied on an aluminum foil and dried to prepare a positive electrode.

87 wt. % of mesophase pitch based fibrous graphite powder that is applied a heat treatment at 3000° C., 10 wt. % of artificial graphite with an average particle size of 5 μm, 1 wt. % of carboxy methyl cellulose, and 2 wt. % of styrene-butadiene rubber are mixed with water as solvent, and slurry was obtained. The obtained slurry was applied on a copper foil and dried to prepare a negative electrode.

A separator was made of a polyethylene porous film.

The positive electrode, separator and negative electrode were laminated in this order, and wound in a spiral form, to prepare an electrode group of 16.7 mm in outside diameter of spiral coil. The electrode group was put in a stainless steel cylindrical can (18 mm in diameter, 65 mm in height). 1 M of lithium hexafluorophosphate is dissolved in a mixed solvent of ethylene carbonate and ethyl methyl carbonate (1:1 by volume). The prepared nonaqueous electrolyte was poured into the can. A valve to open by elevation of internal pressure and a mechanism to disconnect the positive electrode terminal from the positive electrode due to opening of the valve were incorporated. And the opening was sealed, thereby obtaining a cylindrical lithium ion secondary cell.

<Fabrication of Combination Battery>

The lithium ion secondary cell was covered with a vinyl chloride tube as an insulation tube. Twelve covered lithium ion secondary cells were electrically connected in three parallel rows and four series rows by using nickel leads (3P4S) to compose a combination battery, and the positive electrode and negative electrode terminals were connected to a protection control circuit board. The twelve cells were bundled in 6×2 matrix as shown in FIG. 1.

A protection control circuit board was prepared in which a circuit pattern was formed on a glass epoxy insulating substrate of 135 mm in length, 36 mm in width, and 0.8 mm in thickness. This protection control circuit board has an overcharge protection circuit. In a lower case of long box of ABS resin with overall dimensions of 50 mm in shorter width, 140 mm in longer width, and 30 mm in height, the protection control circuit board and combination battery were arranged along the longer side face. Further, the protection control circuit board and combination battery were isolated from each other by using an insulating paper of kraft paper impregnated with varnish. At this time, the insulating paper was kept in tight contact with the combination battery. As a result, the side periphery of all secondary cells in the first row is opposite to the protection control circuit board interposed by the insulating paper. An upper case of a long box was put on the lower case to obtain a lithium ion secondary battery pack in a structure as shown in FIG. 1 to FIG. 4. The inner volume of the lower case was 185 cm³, which can hold the total volume of 59 cm³ of electrolyte contained in the twelve cells composing the combination battery.

The lithium ion secondary battery pack, changeover mechanism for use in stop of AC supply, 16.6V constant voltage battery charging circuit board, AC/DC conversion circuit board, and DC/DC conversion circuit board were assembled in an ATX power supply device of 300 W output. The DC/DC conversion circuit board was arranged on the top of the lithium ion secondary battery pack. At this time, the lithium ion secondary pack was arranged at a position such that the protection control circuit board was located between the inside of the wall portion of the outer case and the combination battery, the wall portion facing the AC/DC conversion circuit board.

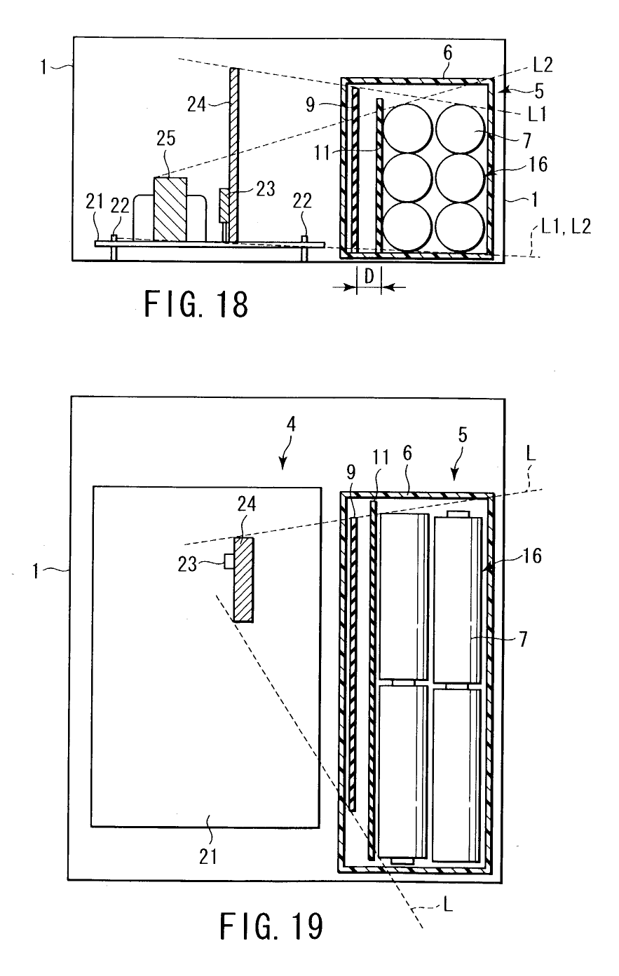

The positional relation between the AC/DC conversion circuit board and the lithium ion secondary battery pack in the ATX power supply housing 1 is schematically shown in a plan view and side view in FIG. 17 and FIG. 18, respectively. The AC/DC conversion circuit board 4 has a board main body 21 made of a glass epoxy insulating substrate of 120 mm in length, 75 mm in width and 0.8 mm in thickness, and a circuit pattern formed on the principal plane of the board main body 21. The circuit pattern includes principal exothermic elements, that is, the regulator 23 with cooling plate 24 and the transformer heat generating part 25. The area S is an area surrounded by a boundary in a plane including as the heat shielding surface the principal plane of the protection control circuit board 9. The boundary is formed by intersecting a plurality of line segments L₁ and a plurality of line segments L₂ with the plane, the line segments L₁ connecting the cooling plate 24 and combination battery 16, and the line segments L₂ connecting the transformer heat generating part 25 and combination battery 16. In FIG. 17 and FIG. 18, the area S is occupied by the heat shielding surface of the protection control circuit board 9, and hence the area X is equal to the area S. The distance D between the combination battery 16 and the protection control circuit board 9 was 7 mm. The insulating plate 11 made of insulating paper contacts with the combination battery 16.

### EXAMPLE 2

A lithium ion secondary battery pack was assembled in the same manner as in Example 1, except that a paper phenol laminate of 1.6 mm in thickness was used as the insulating substrate of the protection control circuit board, and this battery pack was provided in an ATX power supply device, as in Example 1.

### COMPARATIVE EXAMPLE 1

A lithium ion secondary battery pack was fabricated in the same manner as in Example 1, except that the battery pack was rotated by 90 degrees to bring the protection control circuit board on the top.

In the obtained Examples 1 and 2 and Comparative example 1, the following temperatures were measured: the temperature of the AC/DC conversion circuit board during AC supply, the temperature of the surface of the protection control circuit board that faces the AC/DC conversion circuit board (in Comparative example, temperature of the surface closest to the AC/DC conversion circuit), surface temperature of a lithium ion secondary cell A at the protection control circuit board side (in FIG. 1, a lithium ion secondary cell indicated by position A), and surface temperature of a lithium ion secondary cell B in the second row (in FIG. 1, lithium ion secondary cell indicated by position B).

Assuming 170 W to be the electric power required upon interruption of AC external power, the lithium ion secondary battery pack must be discharged at a large current of 20 A in order to supply this electric power (supposing the efficiency of the AC/DC conversion circuit to be 60%). As test operation of substitute power supply, the secondary lithium ion secondary battery pack installed in the ATX power supply device was charged for 3 hours at 5 A and discharge at 20 A, and the discharge duration time was measured until the battery pack voltage dropped to 12V. This operation was repeated 50 times, and the first discharge time and the fiftieth discharge time are compared in Table 1. During this operation, input from the AC external power supply into the AC input terminal of the ATX power supply device was continued.

TABLE 1

| | | Position | Temperature (° C.) | | | | | |
|---|---|---|---|---|---|---|---|---|
| | | of battery | AC/DC | Battery | | | Discharge time | |
| | Type of | control | conversion | control | | | (min) | |
| | insulating | circuit | circuit | circuit | | | First | Fiftieth |
| Sample | substrate | board | board | board | Cell A | Cell B | time | time |
| Example | Glass | AC/DC | 58.2 | 50.2 | 33.0 | 28.8 | 13.5 | 12.7 |
| 1 | epoxy | conversion | | | | | | |
| | substrate | circuit | | | | | | |
| | | side | | | | | | |
| Example | Phenolic | AC/DC | 58.3 | 50.4 | 31.0 | 29.5 | 13.6 | 13.0 |
| 2 | bonded | conversion | | | | | | |
| | paper | circuit | | | | | | |
| | laminate | side | | | | | | |
| Comparative | Glass | Top side | 58.1 | 47.5 | 49.2 | 45.9 | 13.8 | 9.8 |
| example | epoxy | | | | | | | |
| 1 | substrate | | | | | | | |

As clear from Table 1, in the lithium ion secondary battery packs of Examples 1 and 2, the battery temperature in the ATX power supply device is lower than the lithium ion secondary battery pack of Comparative example 1. As a result, the lithium ion secondary battery packs of Examples 1 and 2 were smaller in deterioration after 50 discharges.

### EXAMPLE 3

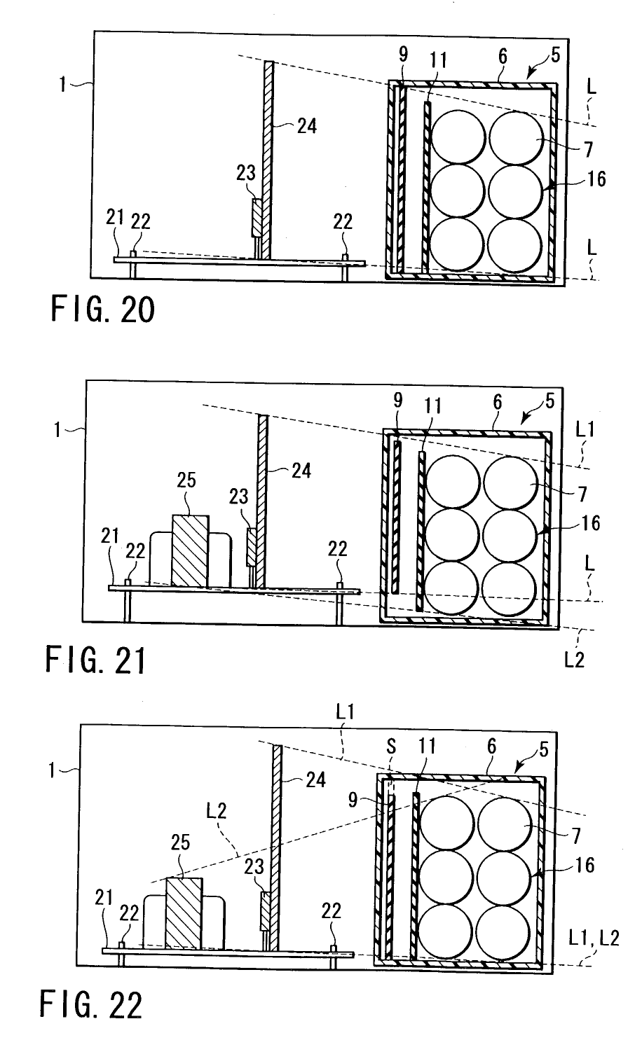

A lithium ion secondary battery pack as explained in Example 1 was installed in an ATX power supply device provided with an AC/DC conversion circuit board having a regulator with cooling plate as an exothermic element, as shown in FIG. 19 and FIG. 20. The area S is an area formed by a plurality of line segments L connecting the cooling plate 24 and combination battery 16, the line segments L intersecting with a plane including as the heat shielding surface the principal plane of the protection control circuit board 9. In FIG. 19 and FIG. 20, since the area S is occupied by the heat shielding surface of the protection control circuit board 9, the area X is equal to the area S.

### EXAMPLE 4

A lithium ion secondary battery pack as explained in Example 1 was installed in an ATX power supply device as shown in FIG. 21, except that a protection control circuit board having a glass epoxy insulting substrate of 135 mm in length, 29 mm in width and 0.8 mm in thickness was used. A configuration from a top view was the same as in FIG. 17.

### EXAMPLE 5

A lithium ion secondary battery pack was prepared same as explained in Example 1, except that it was installed in an ATX power supply device having an AC/DC conversion circuit board with an arrangement of the regulator 23, the cooling plate 24 thereof and the heat generating part 25 of the transformer as shown in FIG. 22. A configuration from a top view is the same as in FIG. 17.

### EXAMPLE 6

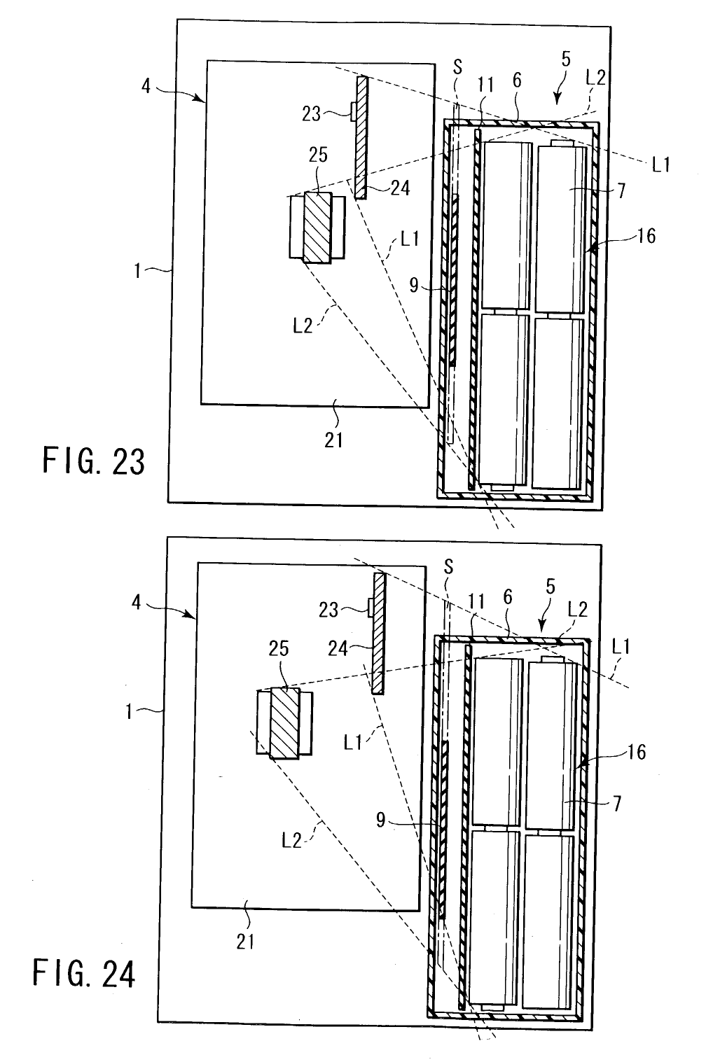

A lithium ion secondary battery pack as explained in Example 1 was installed in an ATX power supply device as shown in FIG. 23, except that a protection control circuit board having a glass epoxy insulting substrate of 68 mm in length, 36 mm in width and 0.8 mm in thickness was used. A configuration from a side view was the same as in FIG. 18.

### EXAMPLE 7

A lithium ion secondary battery pack as explained in Example 1 was installed in an ATX power supply device as shown in FIG. 24, except that a protection control circuit board having a glass epoxy insulting substrate of 68 mm in length, 36 mm in width and 0.8 mm in thickness was used. A configuration from a side view was the same as in FIG. 18.

### EXAMPLE 8

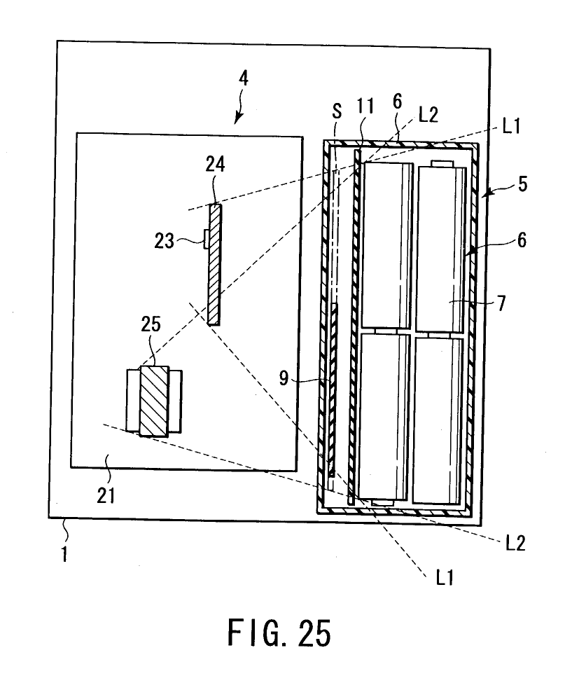

A lithium ion secondary battery pack as explained in Example 1 was installed in an ATX power supply device as shown in FIG. 25, except that a protection control circuit board having a glass epoxy insulting substrate of 68 mm in length, 36 mm in width and 0.8 mm in thickness was used. A configuration from a side view was the same as in FIG. 18.

### EXAMPLE 9

An ATX power supply device was prepared in the same manner as in Example 1, except that a polypropylene plate of 1 mm in thickness was used as an insulating plate of the lithium ion secondary battery pack.

### EXAMPLE 10

A lithium ion secondary battery pack as explained in Example 1 was installed in an ATX power supply device as shown in FIG. 23, except that a protection control circuit board having a glass epoxy insulting substrate of 68 mm in length, 36 mm in width and 0.8 mm in thickness, and a polypropylene plate of 1 mm in thickness as an insulating plate were used. A configuration from a side view was the same as in FIG. 18.

### EXAMPLE 11

An ATX power supply device was prepared in the same manner as in Example 1, except that the distance T of the protection control circuit board and combination battery in a lithium ion secondary battery pack was 2 mm.

Concerning Examples 1, 3 to 11 and Comparative example 1, Table 2 summarizes the type of exothermic elements, area X {ratio (%) of the heat shielding surface of the protection control circuit board in the area S}, presence or absence of heat shield by the AC/DC conversion circuit board, area (%) of the principal plane of the protection control circuit board supposing the projection area that is formed by projecting the side surface of the combination battery on the principal plane to be 100%, type of the insulating plate, and distance D (mm) between the protection control circuit board and the combination battery.

Also in the obtained Examples 3 to 11, the same temperature measurements as mentioned above were conducted together with dummy operation test, and the results are also recorded in Table 2. Table 2 also shows the results of the foregoing Example 1 and Comparative example 1.

TABLE 2

| | | | | Projection | | |
|---|---|---|---|---|---|---|
| | | | | area of | | |
| | | | Heat | battery | | Distance D |
| | | | shield by | control | | between |
| | | | AC/DC | circuit board | | circuit |
| | | | conversion | on combination | Type of | board and |
| | Exothermic | | circuit | battery | insulating | combination |
| Sample | element | Area X | board | surface (%) | plate | battery (mm) |
| Example 1 | Regulator and | S | None | 100 | Insulating | 7 |
| | transformer | | | | paper | |
| Example 3 | Regulator | S | None | 90 | Insulating | 7 |
| | | | | | paper | |
| Example 4 | Regulator and | S | Provided | 80 | Insulating | 7 |
| | transformer | | | | paper | |
| Example 5 | Regulator and | 0.9S | None | 100 | Insulating | 7 |
| | transformer | | | | paper | |
| Example 6 | Regulator and | 0.48S | None | 50 | Insulating | 7 |
| | transformer | | | | paper | |
| Example 7 | Regulator and | 0.42S | None | 50 | Insulating | 7 |
| | transformer | | | | paper | |
| Example 8 | Regulator and | 0.45S | None | 50 | Insulating | 7 |
| | transformer | | | | paper | |
| Example 9 | Regulator and | S | None | 100 | Resin | 7 |
| | transformer | | | | plate | |
| Example 10 | Regulator and | 0.48S | None | 50 | Resin | 7 |
| | transformer | | | | plate | |
| Example 11 | Regulator and | S | None | 100 | Insulating | 2 |
| | transformer | | | | paper | |
| Comparative | Regulator and | 0 | None | 0 | Insulating | 7 |
| example 1 | transformer | | | | paper | |
| | Temperature (° C.) | | | | | |
| | AC/DC | Battery | | | Discharge time | |
| | conversion | control | | | (min) | |
| | circuit | circuit | | | First | Fiftieth |
| Sample | board | board | Cell A | Cell B | time | time |
| Example 1 | 58.2 | 50.2 | 33.0 | 28.8 | 13.5 | 12.7 |
| Example 3 | 57.8 | 49.8 | 32.1 | 28.2 | 13.4 | 12.9 |
| Example 4 | 58.5 | 50.4 | 33.1 | 29.0 | 13.6 | 12.5 |
| Example 5 | 58.5 | 50.1 | 33.6 | 29.2 | 13.7 | 11.9 |
| Example 6 | 58.3 | 50.0 | Max 37.3 | Max 32.1 | 14.0 | 11.4 |
| | | | Min 36.6 | Min 31.8 | | |
| Example 7 | 58.4 | 50.2 | Max 39.6 | Max 34.1 | 13.8 | 11.0 |
| | | | Min 34.9 | Min 33.5 | | |
| Example 8 | 58.1 | 50.2 | Max 44.3 | Max 32.5 | 13.8 | 10.5 |
| | | | Min 33.7 | Min 30.8 | | |
| Example 9 | 58.2 | 50.3 | 29.7 | 27.6 | 13.4 | 13.2 |
| Example 10 | 58.4 | 50.2 | Max 35.8 | Max 30.5 | 13.7 | 11.8 |
| | | | Min 35.6 | Min 30.1 | | |
| Example 11 | 58.4 | 50.1 | 33.4 | 29.1 | 13.6 | 12.4 |
| Comparative | 58.1 | 47.5 | 49.2 | 45.9 | 13.8 | 9.8 |
| example 1 | | | | | | |

As clear from Table 2, in the battery packs of Examples 1 and 3 to 11 having the configuration in which the battery control circuit board is provided between the outer case wall and the combination battery, the outer case wall facing the AC/DC conversion circuit board, the temperature of the combination battery is lower than in Comparative example 1, and the discharge time of the fiftieth cycle is longer. In particular, the battery packs of Examples 1, 3 to 5, 9 and 11 satisfying the formula (1), 0.5×S≦X≦S, were longer in discharge time of the fiftieth cycle as compared with the Examples 6 to 8 and 10.

As described herein, the invention provides a battery pack improved in deterioration of charge and discharge cycle life, and a battery pack with AC/DC conversion circuit board.

Additional advantages and modifications will readily occur to those skilled in the art. Therefore, the invention in its broader aspects is not limited to the specific details and representative Examples shown and described herein. Accordingly, various modifications may be made without departing from the spirit or scope of the general inventive concept as defined by the appended claims and their equivalents.

What is claimed is:

1. A battery pack used as a substitute AC power supply in case of an AC power outage in a power supply system having an AC/DC conversion circuit board that converts an alternating current input into a direct current output, comprising:
an outer case including a wall portion having an outside that faces the AC/DC conversion circuit board;
a combination battery of lithium ion secondary cells provided in the outer case; and
a battery control circuit board provided in the outer case, between the wall portion and the combination battery.

2. A battery pack electrically connected to an AC/DC conversion circuit board comprising an exothermic element, comprising:
an outer case including a wall portion having an outside that faces the AC/DC conversion circuit board;
a combination battery of lithium ion secondary cells provided in the outer case; and
a battery control circuit board provided in the outer case, between the wall portion and the combination battery.

3. The battery pack according to claim 2, wherein the battery control circuit board comprises a glass epoxy substrate or a paper phenol laminate as an insulating substrate.

4. The battery pack according to claim 3, wherein a thickness of the insulating substrate is in a range of 0.8 to 3.2 mm.

5. The battery pack according to claim. 2, wherein the battery control circuit board comprises at least one of an overcharge protection circuit and an overdischarge protection circuit.

6. The battery pack according to claim 2, wherein a surface area of a heat shielding surface of the battery control circuit board is 50% or more of a projection area that is formed by projecting the combination battery on a plane including the heat shielding surface.

7. The battery pack according to claim 2, wherein the outer case comprises a box-shaped case main body and a box-shaped sealing member provided in an opening of the case main body.

8. The battery pack according to claim 2, further comprising an insulating plate provided between the combination battery and the battery control circuit board.

9. The battery pack according to claim 8, wherein the insulating plate is in contact with the combination battery.

10. The battery pack according to claim 2, wherein a distance between the battery control circuit board and the combination battery is in a range of 1 mm to 8 mm.

11. The battery pack according to claim 2, wherein the lithium ion secondary cells are cylindrical in shape, and part of an outer circumferential surface of at least one lithium ion secondary cell faces the battery control circuit board.

12. The battery pack according to claim 2, wherein the following formula (1) is satisfied:
0.5×S≦X≦S (1)
where S is an area where a line segment intersects a plane, the line segment connecting a heat generating part of the exothermic element and the combination battery, the plane including a heat shielding surface of the battery control circuit board, and X is an area where the area S and the heat shielding surface overlap each other.

13. The battery pack according to claim 2, wherein the outside of the wall portion faces the exothermic element, a circuit board main body of the AD/DC conversion circuit board, and a space at the back side of the circuit board main body.

14. The battery pack according to claim 13, wherein the battery control circuit board main body is made of a glass epoxy substrate or a paper phenol laminate.

15. A battery pack with an AC/DC conversion circuit board, comprising:
an AC/DC conversion circuit board comprising an exothermic element; and
a battery pack main body electrically connected to the AC/DC conversion circuit board;
wherein the battery pack main body comprises:
an outer case including a wall portion having an outside that faces the AC/DC conversion circuit board;
a combination battery of lithium ion secondary cells provided in the outer case; and
a battery control circuit board provided in the outer case, between the wall portion and the combination battery.

16. The battery pack with an AC/DC conversion circuit board according to claim 15, wherein the following formula (1) is satisfied:
0.5×S≦X≦S (1)
where S is an area where a line segment intersects a plane, the line segment connecting a heat generating part of the exothermic element and the combination battery, the plane including a heat shielding surface of the battery control circuit board, and X is an area where the area S and the heat shielding surface overlap each other.

17. The battery pack with an AC/DC conversion circuit board according to claim 15, wherein a position of a battery control circuit board main body of the AC/DC conversion circuit board is higher than a position of a bottom of the combination battery and lower than a position of a top of the combination battery.

18. The battery pack with an AC/DC conversion circuit board according to claim 15, wherein the exothermic element comprises at least one element selected from a group consisting of a transformer, a regulator, and an IGBT (insulated gate bipolar transistor).
